(19) United States
(12) Patent Application Publication
(10) Pub. No.: US 2014/0182308 A1
(43) Pub. Date: Jul. 3, 2014

(54) GAS TURBINE ENGINE WITH V-BAND CLAMP CONNECTION FOR COLLECTOR BOX

(71) Applicant: UNITED TECHNOLOGIES CORPORATION, Hartford, CT (US)

(72) Inventors: Robert B. Richardson, Kennebunk, ME (US); Randall J. Hershberger, Coventry, CT (US)

(73) Assignee: UNITED TECHNOLOGIES CORPORATION, Hartford, CT (US)

(21) Appl. No.: 13/729,477

(22) Filed: Dec. 28, 2012

(51) Int. Cl. F02C 7/20

(52) U.S. Cl. CPC F02C 7/20
USPC 60/796; 29/888.02

(57) ABSTRACT

A gas turbine engine includes a turbine section, a compressor section, a bleed air collector box, and a v-band clamp. The compressor section is positioned upstream of the turbine section and includes a compressor case circumferentially surrounding the compressor section. The v-band clamp attaches the bleed air collector box to the compressor case.

### BACKGROUND

The present invention relates to gas turbine engines, and in particular, to collector boxes for industrial gas turbine engines.

Gas turbine engines typically include one or more compressor sections, a combustor section, and one or more turbine sections. Gas flows through such gas turbine engines along a main flow path from the compressor sections where the gas is compressed, through the combustor where the gas is mixed with fuel and combusted, and then through the turbine sections where power is extracted from the gas. In some gas turbine engines, gas compressed by the compressor section can be diverted or “bled” to a second path where it bypasses the combustor and/or the turbine sections. Air can be bled from a gas turbine engine for various operating conditions, such as to assist in starting the gas turbine engine or to assist in emergency stopping of the gas turbine engine.

### SUMMARY

According to the present invention, a gas turbine engine includes a turbine section, a compressor section, a bleed air collector box, and a v-band clamp. The compressor section is positioned upstream of the turbine section and includes a compressor case circumferentially surrounding the compressor section. The v-band clamp attaches the bleed air collector box to the compressor case.

Another embodiment is a gas turbine engine including a turbine section, a compressor section, a sheet metal duct, and first and second v-band clamps. The compressor section is positioned upstream of the turbine section. The compressor section includes a rotor, a compressor case circumferentially surrounding the rotor, and an intermediate case connected to and positioned downstream of the compressor case. The sheet metal duct circumferentially surrounds a portion of the compressor case and a portion of the intermediate case. The first v-band clamp attaches the sheet metal duct to the compressor case. The second v-band clamp attaches the sheet metal duct to the intermediate case.

Another embodiment is a method of attaching a bleed air collector box to a gas turbine engine. The method includes positioning a compressor case axially upstream of and adjacent to a bleed duct and positioning the bleed air collector box circumferentially around a portion of the compressor case and a portion of the bleed duct. The bleed air collector box is attached to the compressor case via a first v-band clamp. The bleed air collector box is attached to the bleed duct via a second v-band clamp.

### BRIEF DESCRIPTION OF THE DRAWINGS

FIG. 1 is a side sectional schematic view of an industrial gas turbine engine.

FIG. 2 is a rear perspective schematic view of a collector box attached to a low pressure compressor and an intermediate case (IMC) of the industrial gas turbine engine of FIG. 1.

FIG. 3 is a front perspective schematic view of the collector box and low pressure compressor of FIG. 2.

FIG. 4 is a perspective sectional schematic view of the intermediate case (IMC) of FIG. 2.

FIG. 5A is a side sectional view of a first v-band clamp for use with the collector box of FIGS. 2 and 3.

FIG. 5B is a side sectional view of a second v-band clamp for use with the collector box of FIGS. 2 and 3.

### DETAILED DESCRIPTION

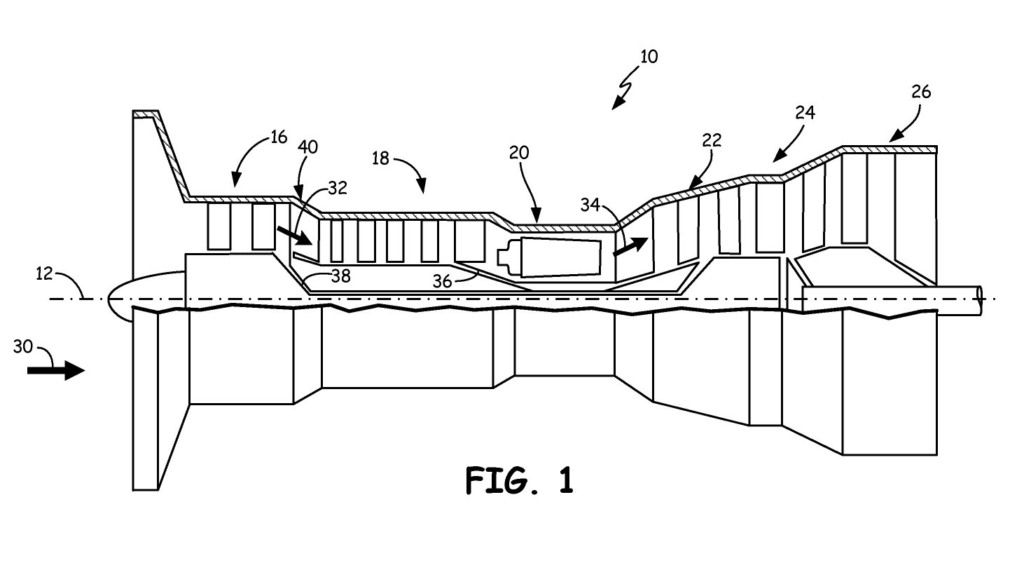

FIG. 1 is a side partial sectional schematic view of gas turbine engine 10. In the illustrated embodiment, gas turbine engine 10 is an industrial gas turbine engine circumferentially disposed about a central, longitudinal axis or axial engine centerline axis 12 as illustrated in FIG. 1. Gas turbine engine 10 includes in series order from front to rear, low pressure compressor section 16, high pressure compressor section 18, combustor section 20, high pressure turbine section 22, and low pressure turbine section 24. In some embodiments, power turbine section 26 is a free turbine section rotating independently from and disposed downstream of both high pressure turbine section 22 and low pressure turbine section 24. Power turbine section 26 may, for example, drive an electrical generator, pump, or gearbox (not shown).

As is known in the art of gas turbines, incoming ambient air 30 becomes pressurized air 32 in the low and high pressure compressor sections 16 and 18. Fuel mixes with pressurized air 32 in combustor section 20, where it is burned. Once burned, combustion gases 34 expand through high and low pressure turbine sections 22, 24 and through power turbine section 26. High and low pressure turbine sections 22 and 24 drive high and low pressure rotor shafts 36 and 38 respectively, which rotate in response to the combustion products and thus rotate the attached high and low pressure compressor sections 18, 16.

Intermediate case (IMC) 40 is positioned between low pressure compressor section 16 and high pressure compressor section 18. IMC 40 defines a flow path for pressurized air 32 between low pressure compressor section 16 and high pressure compressor section 18. IMC 40 also provides structural support for gas turbine engine 10.

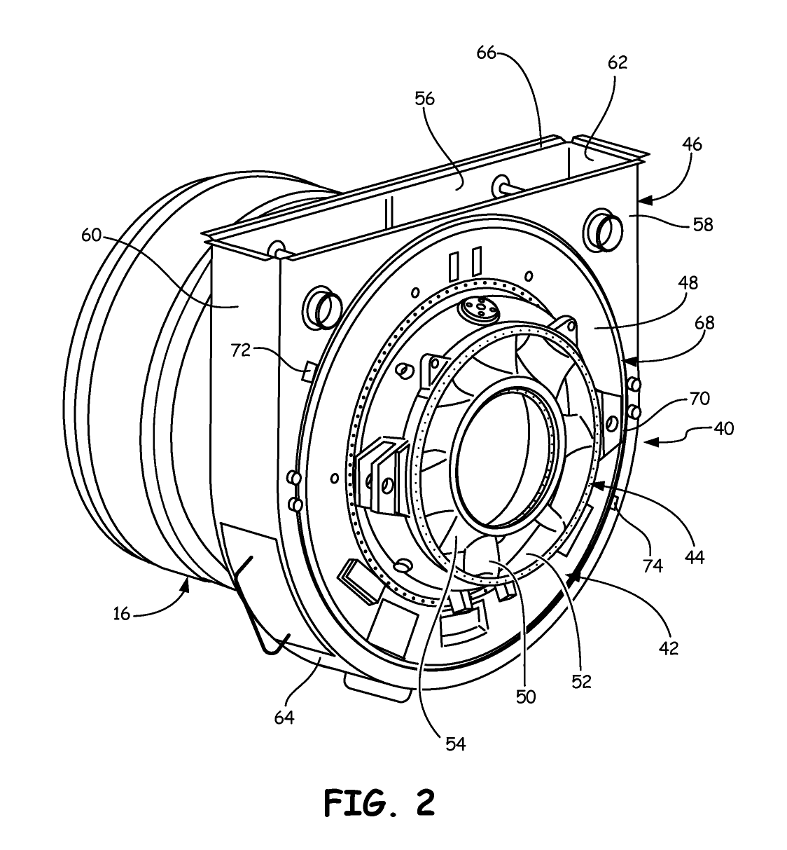

FIG. 2 is a rear perspective schematic view of low pressure compressor section 16, intermediate case (IMC) 40 (which includes bleed duct 42 and IMC centerbody 44), and collector box 46. IMC 40 is connected to low pressure compressor section 16 and is positioned downstream of low pressure compressor section 16. In the illustrated embodiment, bleed duct 42 is a low pressure compressor bleed duct, connected to IMC centerbody 44 and is positioned upstream of IMC centerbody 44.

IMC centerbody 44 includes a plurality of struts 50 connecting outer diameter (OD) case 52 to inner diameter (ID) case 54. In the illustrated embodiment, eight struts 50 transfer load between OD case 52 and ID case 54 to provide structural support for gas turbine engine 10. Struts 50, OD case 52, and ID case 54 combine to define a flow path between low pressure compressor section 16 and high pressure compressor section 18 (shown in FIG. 1).

Collector box 46 is connected to bleed duct 42 for receiving bleed air that passes through bleed duct 42. In the illustrated embodiment, collector box 46 is a sheet metal duct including front wall 56, aft wall 58, side walls 60 and 62, and bottom wall 64. Front wall 56 and aft wall 58 are substantially flat, parallel walls, with front wall 56 positioned axially forward of aft wall 58. Side walls 60 and 62 are substantially flat, parallel walls positioned on opposite sides of gas turbine engine 10 (shown in FIG. 1). Side walls 60 and 62 are connected by curved bottom wall 64, which is positioned at a bottom of gas turbine engine 10. Front wall 56 and aft wall 58 are connected by side wall 60, side wall 62, and bottom wall 64 to define the shape of collector box 46. Side walls 60 and 62 and bottom wall 64 are positioned radially outward of bleed duct 42. Collector box outlet 66 is positioned at a top of collector box 46. In the illustrated embodiment, collector box outlet 66 has a substantially rectangular shape defined by top edges of front wall 56, aft wall 58, and side walls 60 and 62. Compressed air from low pressure compressor section 16 can flow through bleed duct 42 to collector box 46, and then out collector box outlet 66.

Collector box 46 is connected to rear flange 48 of bleed duct 42 via clamp 68. Clamp 68 is a v-band clamp (also called a v-retainer, Marman clamp, or Marmon clamp) including v-band 70 and latches 72 and 74. V-band 70 extends circumferentially around rear flange 48 to connect aft wall 58 of collector box 46 to rear flange 48. Latches 72 and 74 can tighten v-band 70 so as hold collector box 46 tight against rear flange 48. Latches 72 and 74 can include T-bolt latches, quick release latches, over-center latches, C-30 clip latches, T-bolt saddle latches, double trunnion hex-bolt latches, or other latches suitable for the application.

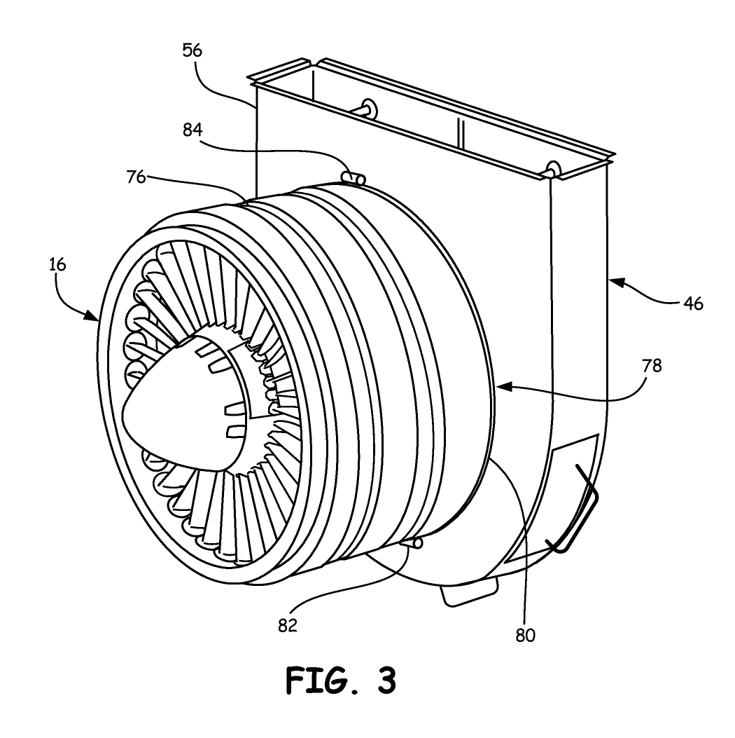

FIG. 3 is a front perspective schematic view of collector box 46 and low pressure compressor section 16. FIG. 3 shows low pressure compressor case 76 extending circumferentially around low pressure compressor section 16. Clamp 78 connects collector box 46 to low pressure compressor case 76. Clamp 78 is a v-band clamp that is similar to clamp 68 (shown in FIG. 2) except clamp 68 has a larger radius. Clamp 78 includes v-band 80 and latches 82 and 84. V-band 80 extends circumferentially around low pressure compressor case 76 to connect front wall 56 of collector box 46 to low pressure compressor case 76. Latches 82 and 84 can tighten v-band 80 so as hold collector box 46 tight against low pressure compressor case 76.

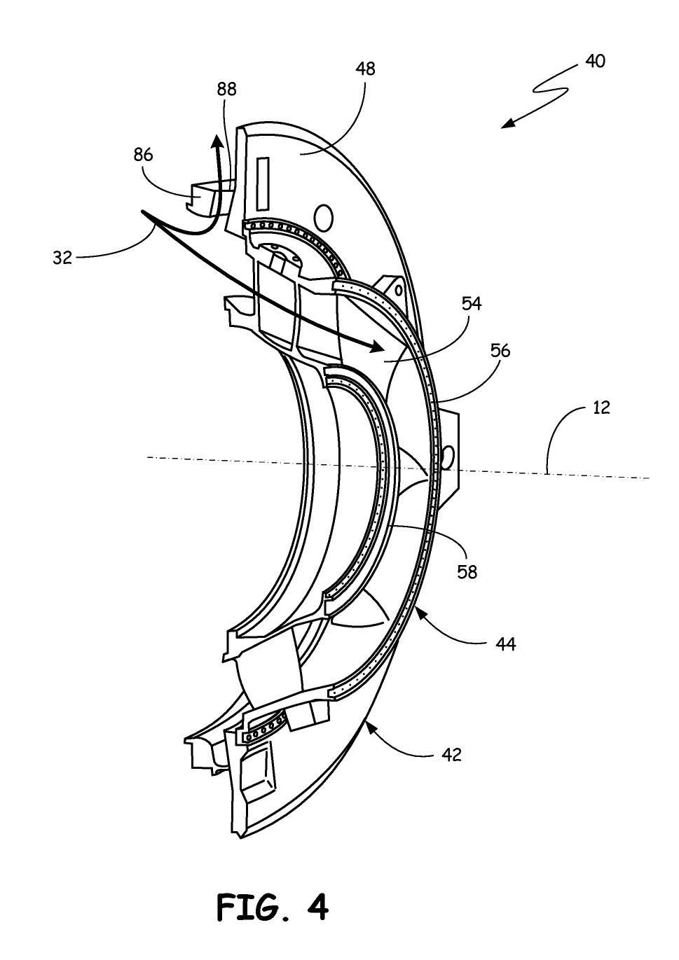

FIG. 4 is a perspective sectional schematic view of intermediate case (IMC) 40. As shown in FIG. 4, bleed duct 42 includes front section 86 integrally formed with rear flange 48. Front section 86 extends forward in a substantially axial direction with respect to axial engine centerline axis 12. Rear flange 48 extends outward in a substantially radial direction with respect to axial engine centerline axis 12. A plurality of bleed duct outlets 88 extend radially outward through front section 86. Front section 86 of bleed duct 42 is an outer diameter flow path for flow of pressurized air 32 flowing in a substantially axial direction from bleed duct 42 to and through IMC centerbody 44.

Pressurized air 32 also flows as bleed air in a substantially radial direction through bleed duct outlets 88 to collector box 46 (shown in FIGS. 2 and 3). Pressurized air 32 can then flow from collector box 46 to the atmosphere, through an exhaust stack or otherwise. In the illustrated embodiment of gas turbine engine 10 (shown in FIG. 1), which is an industrial gas turbine engine, pressurized air 32 can be exhausted directly to the atmosphere without being used for propulsion or cooling, as on some propulsion gas turbine engines.

Front section 86 of bleed duct 42 connects to low pressure compressor case 76 (shown in FIG. 3). In the illustrated embodiment, front section 86 does not connect directly to collector box 46 (shown in FIGS. 3 and 4). In an alternative embodiment, clamp 78 (shown in FIG. 3) can connect front wall 56 (shown in FIG. 3) of collector box 46 directly to front section 86.

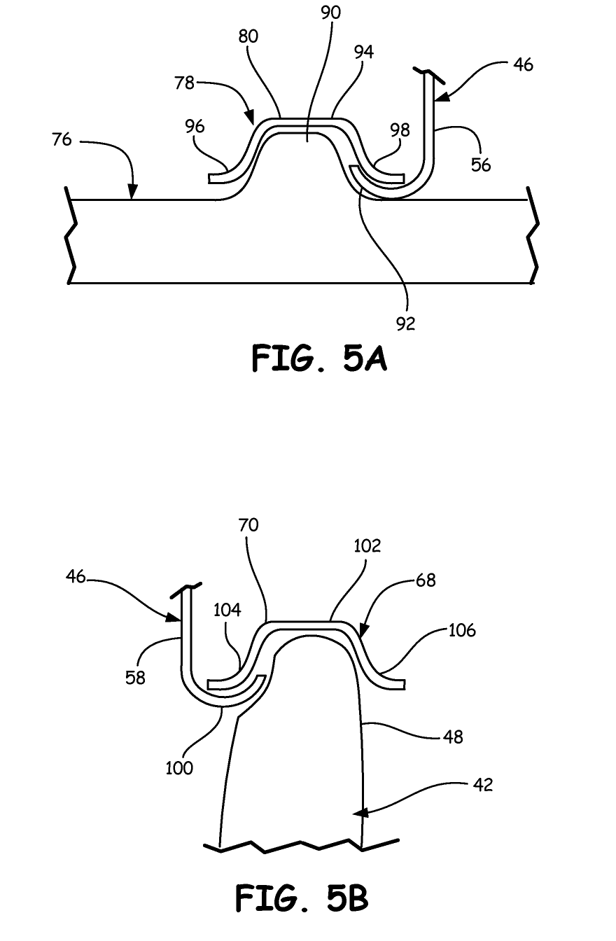

FIG. 5A is a side sectional view of clamp 78 connecting collector box 46 to low pressure compressor case 76. Low pressure compressor case 76 includes flange 90 extending radially outward from and circumferentially around low pressure compressor case 76. Front wall 56 of collector box 46 includes connection portion 92 which is curved axially forward away from collector box 46. Front wall 56 and connection portion 92 have a cross-section that is substantially J-shaped, as shown. Connection portion 92 is positioned adjacent flange 90.

V-band 80 of clamp 78 includes center portion 94 positioned between side portions 96 and 98. V-band 80 has a section that is shaped as an upside down U or upside down V. V-band 80 covers flange 90 and connection portion 92 such that flange 90 and connection portion 92 are positioned axially between side portions 96 and 98 and radially inward of center portion 94. Latches 82 and 84 (shown in FIG. 3) can tighten v-band 80 so as hold connection portion 92 tight against flange 90.

FIG. 5B is a side sectional view of clamp 68 connecting collector box 46 to bleed duct 42. Bleed duct 42 includes rear flange 48 extending radially outward. Aft wall 58 of collector box 46 includes connection portion 100 which is curved axially rearward away from collector box 46. Aft wall 58 and connection portion 100 have a section that is substantially J-shaped (though shown as a backwards J-shape in FIG. 5B). Connection portion 100 is positioned adjacent rear flange 48.

V-band 70 of clamp 68 includes center portion 102 positioned between side portions 104 and 106. V-band 70 has a section that is shaped as an upside down U or upside down V. V-band 70 covers rear flange 48 and connection portion 100 such that rear flange 48 and connection portion 100 are positioned axially between side portions 104 and 106 and radially inward of center portion 102. Latches 72 and 74 (shown in FIG. 2) can tighten v-band 70 so as hold connection portion 100 tight against rear flange 48.

Clamps 68 and 78 can thus connect collector box 46 to bleed duct 42 and low pressure compressor case 76 of gas turbine engine 10. Clamps 68 and 78 can be relatively large, for example, having a diameter in excess of about 50 inches (about 1.27 meters). Because clamps 68 and 78 can be relatively large, collector box 46 can also be relatively large and can extend circumferentially around bleed duct 42 and low pressure compressor case 76. Using clamps 68 and 78 can reduce or eliminate the number of bolts and bolt holes needed to connect collector box 46 to gas turbine engine 10. Thus, attaching collector box 46 to gas turbine engine 10 via clamps 68 and 78 can reduce the cost of and the time to manufacture and assemble gas turbine engine 10.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, low pressure compressor section 16, intermediate case 40, and collector box 46 need not be shaped and configured precisely as illustrated, but could be modified as appropriate for a given application.

The following are non-exclusive descriptions of possible embodiments of the present invention.

### Discussion of Possible Embodiments

A gas turbine engine can include a turbine section, a compressor section, a bleed air collector box, and a v-band clamp. The compressor section can be positioned upstream of the turbine section and include a compressor case circumferentially surrounding the compressor section. The v-band clamp can attach the bleed air collector box to the compressor case.

The gas turbine engine of the preceding paragraph can optionally include, additionally and/or alternatively any, one or more of the following features, configurations and/or additional components:
the bleed air collector box can extend circumferentially around a portion of the compressor case;
the bleed air collector box can include a front wall, an aft wall positioned axially aft of and substantially parallel to the front wall, first and second side walls connecting the front wall to the aft wall, and a curved bottom wall connecting the front wall to the aft wall and the first side wall to the second side wall;
the first and second side walls and the curved bottom wall can be positioned radially outward of a bleed duct connected axially downstream of the compressor case;
top edges of the front wall, the aft wall, and the first and second side walls can define a substantially rectangular collector box outlet;
the bleed air collector box can include a front wall with a connection portion curved away from the collector box, the compressor case can include a flange, and the v-band clamp can connect the connection portion to the flange;
the front wall and the connection portion can have a cross-section that is substantially J-shaped;
the v-band clamp can include a v-band and first and second latches for tightening the v-band;
a bleed duct can have a plurality of bleed duct outlets extending radially outward for flowing bleed air from the compressor section into the bleed air collector box; and/or
the v-band clamp is a first v-band clamp and a second v-band clamp can attach the bleed air collector box to a flange of the gas turbine engine.

A gas turbine engine can include a turbine section, a compressor section, a sheet metal duct, and first and second v-band clamps. The compressor section can be positioned upstream of the turbine section. The compressor section can include a rotor, a compressor case circumferentially surrounding the rotor, and an intermediate case connected to and positioned downstream of the compressor case. The sheet metal duct can circumferentially surround a portion of the compressor case and a portion of the intermediate case. The first v-band clamp can attach the sheet metal duct to the compressor case. The second v-band clamp can attach the sheet metal duct to the intermediate case.

The gas turbine engine of the preceding paragraph can optionally include, additionally and/or alternatively any, one or more of the following features, configurations and/or additional components:
the sheet metal duct can include a front wall, an aft wall positioned axially aft of and substantially parallel to the front wall, first and second side walls connecting the front wall to the aft wall, and a curved bottom wall connecting the front wall to the aft wall and the first side wall to the second side wall;
the intermediate case can include an intermediate case centerbody and a bleed duct connected to the intermediate case centerbody;
the bleed duct can include a front section having a plurality of bleed duct outlets extending radially outward and a rear flange and the second v-band clamp can connect an aft wall of the sheet metal duct to the rear flange;
the gas turbine engine can be an industrial gas turbine engine and the turbine section can include a high pressure turbine section, a low pressure turbine section, and a power turbine section positioned downstream of the low and high pressure turbine sections; and/or
the sheet metal duct can have a first connection portion with a first cross-section that is substantially J-shaped positioned radially inward of the first v-band clamp and the sheet metal duct can have a second connection portion with a second cross-section that is substantially J-shaped positioned radially inward of the second v-band clamp.

A method of attaching a bleed air collector box to a gas turbine engine can include positioning a compressor case axially upstream of and adjacent to a bleed duct and positioning the bleed air collector box circumferentially around a portion of the compressor case and a portion of the bleed duct. The bleed air collector box can be attached to the compressor case via a first v-band clamp. The bleed air collector box can be attached to the bleed duct via a second v-band clamp.

The method of the preceding paragraph can optionally include, additionally and/or alternatively any, one or more of the following features, configurations and/or additional steps:
the first v-band clamp can be tightened via first and second latches an the second v-band clamp can be tightened via third and fourth latches;
tightening the first v-band clamp can hold a first curved connection portion of the bleed air collector box tight against a flange of the compressor case and tightening the second v-band clamp can hold a second curved connection portion of the bleed air collector box tight against a flange of the bleed duct; and/or
the compressor case can be connected to the bleed duct and the bleed duct can be connected to an intermediate case centerbody axially downstream of the bleed duct.

1. A gas turbine engine comprising:
a turbine section;
a compressor section positioned upstream of the turbine section and including a compressor case circumferentially surrounding the compressor section;
a bleed air collector box; and
a v-band clamp attaching the bleed air collector box to the compressor case.

2. The gas turbine engine of claim 1, wherein the bleed air collector box extends circumferentially around a portion of the compressor case.

3. The gas turbine engine of claim 1, wherein the bleed air collector box comprises:
a front wall;
an aft wall positioned axially aft of and substantially parallel to the front wall;
first and second side walls connecting the front wall to the aft wall; and
a curved bottom wall connecting the front wall to the aft wall and the first side wall to the second side wall.

4. The gas turbine engine of claim 3, wherein the first and second side walls and the curved bottom wall are positioned radially outward of a bleed duct connected axially downstream of the compressor case.

5. The gas turbine engine of claim 3, wherein top edges of the front wall, the aft wall, and the first and second side walls define a substantially rectangular collector box outlet.

6. The gas turbine engine of claim 1, wherein the bleed air collector box comprises a front wall with a connection portion curved away from the collector box, wherein the compressor case comprises a flange, and wherein the v-band clamp connects the connection portion to the flange.

7. The gas turbine engine of claim 6, wherein the front wall and the connection portion have a cross-section that is substantially J-shaped.

8. The gas turbine engine of claim 1, wherein the v-band clamp comprises a v-band and first and second latches for tightening the v-band.

9. The gas turbine engine of claim 1, and further comprising:
a bleed duct having a plurality of bleed duct outlets extending radially outward for flowing bleed air from the compressor section into the bleed air collector box.

10. The gas turbine engine of claim 1, wherein the v-band clamp is a first v-band clamp, and further comprising:
a second v-band clamp attaching the bleed air collector box to a flange of the gas turbine engine.

11. A gas turbine engine comprising:
a turbine section;
a compressor section positioned upstream of the turbine section and including:
a rotor;
a compressor case circumferentially surrounding the rotor; and
an intermediate case connected to and positioned downstream of the compressor case;
a sheet metal duct circumferentially surrounding a portion of the compressor case and a portion of the intermediate case;
a first v-band clamp attaching the sheet metal duct to the compressor case; and
a second v-band clamp attaching the sheet metal duct to the intermediate case.

12. The gas turbine engine of claim 11, wherein the sheet metal duct comprises:
a front wall;
an aft wall positioned axially aft of and substantially parallel to the front wall;
first and second side walls connecting the front wall to the aft wall; and
a curved bottom wall connecting the front wall to the aft wall and the first side wall to the second side wall.

13. The gas turbine engine of claim 11, wherein the intermediate case comprises:
an intermediate case centerbody; and
a bleed duct connected to the intermediate case centerbody.

14. The gas turbine engine of claim 13, wherein the bleed duct comprises:
a front section having a plurality of bleed duct outlets extending radially outward; and
a rear flange, wherein the second v-band clamp connects an aft wall of the sheet metal duct to the rear flange.

15. The gas turbine engine of claim 11, wherein the gas turbine engine is an industrial gas turbine engine, and wherein the turbine section comprises:
a high pressure turbine section;
a low pressure turbine section; and
a power turbine section positioned downstream of the low and high pressure turbine sections.

16. The gas turbine engine of claim 11, wherein the sheet metal duct has a first connection portion having a first cross-section that is substantially J-shaped positioned radially inward of the first v-band clamp and wherein the sheet metal duct has a second connection portion having a second cross-section that is substantially J-shaped positioned radially inward of the second v-band clamp.

17. A method of attaching a bleed air collector box to a gas turbine engine, the method comprising:
positioning a compressor case axially upstream of and adjacent to a bleed duct;
positioning the bleed air collector box circumferentially around a portion of the compressor case and a portion of the bleed duct;
attaching the bleed air collector box to the compressor case via a first v-band clamp; and
attaching the bleed air collector box to the bleed duct via a second v-band clamp.

18. The method of claim 17, and further comprising:
tightening the first v-band clamp via first and second latches; and
tightening the second v-band clamp via third and fourth latches.

19. The method of claim 18, wherein tightening the first v-band clamp holds a first curved connection portion of the bleed air collector box tight against a flange of the compressor case and wherein tightening the second v-band clamp holds a second curved connection portion of the bleed air collector box tight against a flange of the bleed duct.

20. The method of claim 17, and further comprising:
connecting the compressor case to the bleed duct; and
connecting the bleed duct to an intermediate case centerbody axially downstream of the bleed duct.
